(19) United States
(12) Patent Application Publication
(10) Pub. No.: US 2022/0068147 A1
(43) Pub. Date: Mar. 3, 2022

(54) METHOD AND SYSTEM FOR ASSISTING THE NAVIGATION OF AN AIRCRAFT, AND ASSOCIATED AIRCRAFT

(71) Applicant: AIRBUS HELICOPTERS, Marignane (FR)

(72) Inventors: Remi GIRARD, Istres (FR); Nicolas BELANGER, Fos Sur Mer (FR)

(73) Assignee: AIRBUS HELICOPTERS, Marignane (FR)

(21) Appl. No.: 17/445,515

(22) Filed: Aug. 20, 2021

(30) Foreign Application Priority Data
Sep. 3, 2020 (FR) 2008941

(51) Int. Cl. G08G 5/00; B64D 47/08; G01C 21/20

(52) U.S. Cl. CPC G08G 5/0034; G01C 21/20; B64D 47/08; G08G 5/0047

(57) ABSTRACT

A method and a system for assisting the navigation of an aircraft, the system comprising: a graph generator for generating a graph comprising nodes and arcs corresponding to a set of preferred waypoints and routes for the aircraft; a memory installed on board the aircraft for storing the graph; a planning member configured to plan a mission and to enter at least one destination position for the mission; an identification means configured to identify a current position of the aircraft in the graph; and a computer configured to calculate a flight path by means of the graph in order to move from the current position of the aircraft to the destination position.

### CROSS-REFERENCE TO RELATED APPLICATIONS

This application claims priority to French patent application No. FR 20 08941 filed on Sep. 3, 2020, the disclosure of which is incorporated in its entirety by reference herein.

### TECHNICAL FIELD

The present disclosure relates to the technical field of methods and systems for assisting the navigation of aircraft.

### BACKGROUND

Such methods or systems also make it possible to reduce the workload of a pilot and/or a co-pilot of an aircraft by indicating, for example, a heading to be followed and/or by generating command instructions for piloting the aircraft along a flight path.

Such aircraft may, for example, be airplanes or rotorcraft, and may have one or more rotors contributing at least to the lift of the aircraft in the air. In addition, such an aircraft may carry a pilot or may carry no pilot. In the second case, the aircraft may be piloted remotely or may indeed be piloted autonomously along a fully or partially predetermined flight path. Such an aircraft may then be formed, in particular, by a drone.

Generally, methods and systems for assisting the navigation of aircraft use a receiver module of a satellite positioning system such as, in particular, GPS, an acronym for the expression “Global Positioning System”, GLONASS, an acronym for the Russian expression “GLObal'naya NAvigatsionnaya Sputnikovaya Sistema”, or indeed the GALILEO system.

These navigation assistance systems make it possible to identify a current position of an aircraft defined by latitude, longitude and possibly altitude coordinates in a terrestrial reference frame. Knowing the current position and a position of a predetermined destination for the aircraft's mission, such navigation assistance systems then make it possible to provide at least one preferred flight route or flight path, for example for limiting fuel consumption or avoiding potentially dangerous zones.

Furthermore, however, such navigation assistance systems may fail or their accuracy may be affected if only a small number of orbiting satellites is “visible” to the aircraft during its mission. In addition, jamming systems may also hinder or even prevent reception of the signals transmitted by the various satellites.

The lack of accuracy and/or the loss of reception of these signals may then prove critical for the aircraft, which may be forced to shorten its mission or even make an emergency landing.

Moreover, unmanned aerial vehicles or drones equipped with flight control systems and, more particularly, with vision-based navigation systems, are also known, as described in document WO2018102559.

Such systems thus use at least one camera to determine their position in space. They make it possible to predict whether there will be sufficient identifiable visual features in the future. These systems thus make it possible to limit a flight zone of the mission with respect to initial planning instructions.

However, these navigation assistance systems are implemented locally on the drone and incrementally only during the drone's mission. Such navigation assistance systems do not make it possible to favor one flight path over another from the outset, before the mission, in order to enable the aircraft to reach a predetermined destination position.

As disclosed in the article titled “A Bio-Inspired Goal-Directed Visual Navigation Model for Aerial Mobile Robots” written by Jun Mao et al and published online on 12 May 2020 on the website of the Journal of Intelligent and Robotic Systems, Kluwer, Dordrecht, a vision-based navigation assistance method intended to be implemented by autonomous aircraft is known.

This article discloses, in particular, the generation of a graph comprising nodes and arcs corresponding to a set of preferred waypoints and routes for an aircraft, the planning of a mission to reach a destination position, and the identification of a current position of the aircraft in the graph by means of images captured in flight during an aircraft's mission.

Also disclosed is the calculation, by means of the graph, of a flight path in order to move from the current position of the aircraft to the destination position. However, the calculation of the flight path is carried out depending on image usability indices of the nodes of the graph, by acquiring images in flight and by identifying, in these images, characteristic points at the various nodes.

Thus, such a navigation method makes it possible to perform dead reckoning navigation by means of a heading to be followed when leaving a node and a substantially constant speed of movement of the aircraft between two consecutive nodes. In addition, since the current position is identified only at a node of the graph, the possible updating of the trajectory is possible only locally at this node.

Similarly, document US 2016/003620 describes another method for assisting navigation for a traveller by means of a graph comprising nodes and arcs, each arc being assigned a cost for traversing it.

Furthermore, this document does not allow a vision-based flight path to be calculated depending on image usability indices corresponding to the probability of satisfying a step of identifying a current position on the graph.

### SUMMARY

An object of the present disclosure is therefore to propose an alternative navigation assistance method and system that makes it possible to overcome the above-mentioned limitations. Indeed, this navigation assistance method is autonomous and therefore does not depend on electromagnetic signals transmitted by systems external to the aircraft such as, for example, satellites, mobile phone antennas or antennas of a wireless communication protocol such as, in particular, Wi-Fi.

Another object of the disclosure is to enable planning of the safest and most suitable predetermined flight path for arriving at a destination position without the need for an external positioning system.

The disclosure therefore relates to a method for assisting the navigation of an aircraft, the method including the steps of:

generating a graph comprising nodes and arcs corresponding to a set of preferred waypoints and routes for the aircraft, each arc connecting two nodes to each other and each node being connected to at least one other node;

storing the graph in a memory installed on board the aircraft;

planning a mission to reach a destination position;

identifying a current position of the aircraft in the graph, the step of identifying the current position being carried out by means of images captured in flight during the aircraft's mission; and

calculating a flight path by means of the graph in order to move from the current position of the aircraft to the destination position.

This method is remarkable in that each arc of the graph is assigned an image usability index making it possible to quantify a probability of satisfying the step of identifying the current position, the step of identifying the current position being carried out at any instant on one of the arcs of the graph arranged between two consecutive nodes, and in that the calculation of a flight path is carried out depending on the image usability indices of the arcs.

In other words, such a navigation assistance method identifies the current position by acquiring a plurality of images in flight. The images are then analyzed to identify characteristic points, also referred to as “landmarks”, whose coordinates are known. These coordinates are then stored in the memory installed on board the aircraft.

These images captured in flight are then analyzed to identify characteristic points, the coordinates of which are known in a reference frame. Such coordinates are stored in a memory installed on board the aircraft that may be combined with or separate from the memory for storing the graph. For example, the coordinates may, for example, be geographical coordinates such as a latitude and a longitude of the terrestrial reference frame.

The graph can then be plotted in the reference frame comprising the coordinates of the characteristic points. Moreover, when the coordinates of two characteristic points are known, it is thus possible to calculate the distance separating these two points in a conventional manner. For example, analyzing the images makes it possible to measure a distance separating these two points on these images and to deduce therefrom, by means of a proportionality rule and vectorial and/or trigonometric calculations, the distance separating these points from the aircraft and therefore the coordinates corresponding to the current position of the aircraft.

Such a method is generated autonomously on the aircraft and makes it possible, at any time, to determine the current position of the aircraft on an arc of the graph by following the previously calculated flight path. Identifying the current position on the arcs makes it possible to constantly identify a multitude of characteristic points and therefore improve the probability of successfully identifying, at any instant, the current position in the graph and therefore the tracking of the flight path. The trajectory followed by the aircraft is thus updated at any time.

Such a navigation assistance method is therefore independent of any external signal and consequently has a very high level of reliability with respect to other known navigation assistance methods.

Furthermore, since the arcs can represent and extend over long distances, the flight path can be tracked even in conditions of limited visibility, such as, for example, at night, or in foggy or rainy weather.

Thus, such a navigation assistance method helps the aircraft avoid deviating from its flight path whatever the visibility conditions.

The method may also include one or more of the following features.

Advantageously, the image usability indices being between 0 and 1, the step of calculating a flight path may give preference to arcs having the highest image usability indices.

In other words, for each possible flight path, the method adds up the image usability indices of the different arcs and can then select or propose for selection the flight path assigned the highest score. Such a flight path is then considered to be the safest for vision-based navigation of the aircraft.

This first preferred flight path can therefore be generated on the ground before a mission of the aircraft. Furthermore, if, for a particular reason, such as, for example, the presence of a new or unidentified obstacle, the pilot of the aircraft decides to depart from this first flight path, the method can then calculate a new flight path in flight, by means of the graph, in order to move from a current position of the aircraft to a predetermined destination position.

Similarly, the pilot may also choose to modify the position of the predetermined destination of his or her mission in flight. In this case, the method can then calculate a new flight path in flight by means of the graph in order to move from a current position of the aircraft to the new destination position.

Moreover, according to a first embodiment of the disclosure, the step of generating a graph may be carried out by means of imaging data.

Consequently, the step of generating the graph may use computer image analysis techniques in order to define zones containing obstacles for this type of vision-based navigation, and to define zones suitable for this type of navigation. Mapping algorithms are fed with images provided, for example, by a database of images previously acquired by an aircraft, satellite images or any other means.

These images or aerial views then constitute data making it possible to identify points of interest, interesting visual features or landmarks that will then be used during the step of identifying the current position of the aircraft. The previously geolocated landmarks are advantageously used to help accurately locate the current position and reduce a possible error in terms of divergence from the flight path.

Different landmark recognition methods have been known for some years.

Mention may be made, in particular, of a method referred to as “Landmark Fingerprinting” by the authors Mikael Mannberga and Al Savvaris. Other methods, consisting in particular of grouping together landmarks, are also known, referred to as “Object recognition based on ORB and self-adaptive kernel clustering algorithm” by the authors Zhang and Miao, “Automatic landmark selection for UAV autonomous navigation” by the authors Melo, Filho and Shiguemori, “Automatic landmark selection based on feature clustering for UAV Navigation” by the authors Filho and Shiguemori, “UAV Visual autolocalization based on automatic landmark recognition” by the authors P. S. Filho, E. H. Shiguemori and O. Saotome and “Aerial vehicle localization using generic landmarks” by the authors Mark P. DeAngelo and Joseph F. Horn. All these methods demonstrate that the quantity of points of interest is important information for vision-based navigation.

In addition, according to this first embodiment of the disclosure, the step of generating the graph can be carried out on the ground prior to the aircraft's mission as a function of a predetermined start position and a predetermined destination position.

Such a graph may, for example, comprise a three-dimensional matrix or a superposition of a plurality of two-dimensional graphs. A merging step then makes it possible to merge a first set formed by 2D graphs with a second set formed by connecting arcs, the merging step generating a 3D non-oriented graph, which can then be used to generate a flight path for the aircraft.

For example, the 2D graphs may have a “quadtree” adaptive mesh as disclosed, in particular, by the applicant in document FR3080678.

Furthermore, according to a second embodiment of the disclosure, the step of generating a graph may be carried out by means of the images captured in flight during the aircraft's mission.

In this case, the method can constantly update the graph by using mapping algorithms fed with images provided by cameras installed on board the aircraft during its mission.

According to a third embodiment of the disclosure, the step of generating a graph may be carried out by means of digital terrain models.

For example, a digital terrain model may consist of a raster map making it possible to know, according to a certain resolution and according to a regular mesh applied to the surface of the earth, the altitude on each cell. The size of the cells is predetermined and is referred to as the spatial resolution. Each cell has a value representing the altitude of the zone.

According to a fourth embodiment of the disclosure, the step of generating a graph may be carried out by means of a geographic information system database.

The graph may then include vector layers representing roads, water zones, buildings, land use, etc. These different geographical entities are represented by geometrical objects such as, for example, points, lines, or polygons. They are defined by their coordinates in a projection system of the graph.

Advantageously, the various embodiments of the disclosure may be combined with one another. In this case, the step of generating a graph may be carried out by means of imaging data, digital terrain models and a geographic information system database.

In other words, the graph may be generated by combining the various data sources described above. Such a graph is then particularly rich in information and enables the aircraft to select a flight path by favoring “vision-based” navigation that is as safe as possible in the absence of any other navigation assistance method.

According to another embodiment, the image usability indices may be calculated as a function of at least one parameter selected from the group comprising a texture level of zones of the graph, a number of items of imaging data included in the zones of the graph, a confidence level relating to recognition of the imaging data, the existence of a spatial relationship between the items of imaging data, an altitude corresponding to the current position of the aircraft and the flight conditions of the mission.

One or more of these parameters can thus enable the navigation assistance method to calculate the image usability indices of each arc of the graph. Naturally, the higher the number of parameters used simultaneously, the higher the image usability indices and the safer and more effective the navigation assistance method.

According to such a vision-based navigation assistance method, the expression “texture level of a zone of the graph” refers to a region of the graph that may be visually textured to a greater or lesser extent, i.e., that may have variations in composition. For example, a stretch of water, sand or snow may be visually uniform and represent a first texture level. On the other hand, a stretch of land may be visually very heterogeneous and comprise, for example, earth, rocks, fields, forests, cities, etc. A stretch of land may thus correspond to a second texture level different from the first texture level.

The disclosure also relates to a system for assisting the navigation of an aircraft, the system including:

a graph generator for generating a graph comprising nodes and arcs corresponding to a set of preferred waypoints and routes for the aircraft, each arc connecting two nodes to each other and each node being connected to at least one other node;

a memory installed on board the aircraft for storing the graph;

a planning member configured to plan a mission and to enter at least one destination position for the mission;

an identification means configured to identify a current position of the aircraft in the graph, the means for identifying the current position of the aircraft using at least images captured in flight during the aircraft's mission; and

a computer configured to calculate a flight path by means of the graph in order to move from the current position of the aircraft to the destination position.

Such a navigation assistance system is remarkable in that the graph generator is configured to assign an image usability index to each arc of the graph, making it possible to quantify, for the identification means, a probability of identifying the current position of the aircraft, the identification means identifying, at any instant, the current position of the aircraft on one of the arcs of the graph arranged between two consecutive nodes, and in that the computer calculates the flight path depending on the image usability indices of the arcs.

Consequently, such a navigation assistance system may be arranged completely or partially on an aircraft. Optionally, the graph generator may be arranged in a ground station that transmits the graph to an onboard memory prior to the mission.

For example, the planning member may include a keyboard, a touchscreen or a touchpad enabling a pilot to enter the destination position. Furthermore, such a planning member may have a screen allowing a map to be displayed having landing areas or landing strips that can be selected manually by the pilot of the aircraft.

In a particular embodiment, the graph generator, the identification means and the computer may be separate from one another.

Alternatively, and according to another embodiment, the graph generator, the identification means and the computer may be combined and form a single processing unit.

Such a processing unit may, for example, comprise at least one processor and at least one memory, at least one integrated circuit, at least one programmable system, at least one logic circuit, these examples not limiting the scope given to the expression “processing unit”. The term “processor” may refer equally to a central processing unit (CPU), a graphics processing unit (GPU), a digital signal processor (DSP), a microcontroller, etc.

In practice, the system may comprise at least one camera installed on board the aircraft in order to generate the images captured in flight during the aircraft's mission.

Such images are then advantageously transmitted to the onboard memory in order to be used either by the graph generator, the identification means and/or the computer.

Advantageously, the system may be installed on board the aircraft.

In other words, in addition to the onboard memory, the graph generator, the planning member, the identification means and the computer are also installed on board the aircraft.

The present disclosure also relates to an aircraft that is remarkable in that it comprises a system for assisting the navigation of an aircraft as described above.

Such an aircraft thus comprises an autonomous navigation assistance system that is not dependent on electromagnetic signals transmitted by other systems external to the aircraft.

According to one embodiment, the aircraft comprising a satellite positioning system, the navigation assistance system may be configured to compensate for a malfunction of the satellite positioning system.

An aircraft according to the disclosure makes it possible to provide a priori knowledge of the terrain. The “vision-based” navigation assistance is thus safe. In the event of loss of the signals transmitted by the satellite positioning system, the vision-based navigation system according to the disclosure can use the on-board graph. As soon as the signals transmitted by the satellite positioning system are lost, or when an event occurs that triggers the need for vision-based navigation, an optimal flight path is calculated based on the graph by considering the current position of the aircraft at the instant when the undesirable event occurs.

Furthermore, such a navigation assistance system thus makes it possible to overcome a malfunction of the satellite positioning system, which has the effect of improving safety on board the aircraft.

In practice, the navigation assistance system may be configured to interface with a control unit for piloting the aircraft.

Thus, the vision-based navigation assistance system may be incorporated into an existing navigation architecture. When a signal transmitted by the satellite positioning system is lost, the vision-based navigation assistance system may then, for example, interface with at least one of the systems comprising the flight control system, generally referred to as the flight management system, the automatic pilot of the aircraft, the crew of the aircraft, the aircraft management system, generally referred to as the vehicle management system, and vision algorithms.

Such an aircraft thus comprises a multi-agent intelligent navigation assistance tool. This relationship makes it possible to propose new optimal flight paths for vision-based navigation in flight.

### BRIEF DESCRIPTION OF THE DRAWINGS

The disclosure and its advantages appear in greater detail from the following description of examples given by way of illustration with reference to the accompanying figures, in which:

FIG. 1 is a side view of an aircraft according to the disclosure;

FIG. 2 is a diagram showing a navigation assistance system according to the disclosure;

FIG. 3 is a graph capable of being generated by the navigation assistance system according to the disclosure; and

FIG. 4 is a logic diagram showing a navigation assistance method according to the disclosure.

### DETAILED DESCRIPTION

Elements present in more than one of the figures are given the same references in each of them.

As mentioned above, the disclosure relates to the field of systems for assisting the navigation of aircraft.

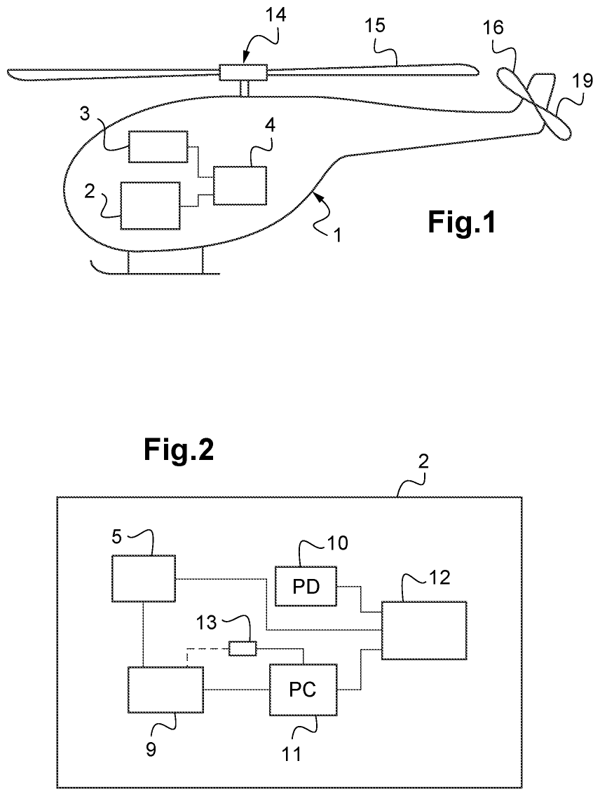

As shown in FIG. 1, an aircraft 1 may thus comprise such a navigation assistance system 2. The aircraft 1 also comprises a satellite positioning system 3 for receiving signals transmitted by satellites and for deducing therefrom a current position of the aircraft 1 in a terrestrial reference frame.

The navigation assistance system 2 and the satellite positioning system 3 are connected by wired or wireless means with a control unit 4 for piloting the aircraft 1.

In particular, such a control unit 4 can be used to control servo-controls capable of moving aerodynamic members of the aircraft 1. When the aircraft 1 is formed by a rotorcraft, as shown in FIG. 1, the aerodynamic members may comprise blades 15 of a main rotor 14 and blades 19 of a rear rotor 16.

Consequently, the navigation assistance system 2 can be integrated into an existing navigation architecture of an aircraft 1. The vision-based navigation assistance system 2 can thus interface with the flight management system, the autopilot, the crew of the aircraft 1, the vehicle management system and vision algorithms.

The navigation assistance system 2 can also provide piloting information to a pilot of the aircraft 1 so as to indicate to him or her a heading or a preferred direction to be followed in order to carry out a mission.

The navigation assistance system 2 can in particular be configured to compensate for a malfunction of a satellite positioning system 3.

Furthermore, such a system 2 may also use the graph 6 to create, by means of threshold logic, a prohibited space and a permitted space for vision-based navigation of the aircraft 1.

The system 2 also makes it possible to generate a graph of distance with respect to this authorized space.

Three-dimensional graph management algorithms such as the D* or A* algorithm make it possible to focus on calculating the optimal path in terms of energy consumption in a three-dimensional non-cooperative environment. Such an algorithm then uses a concept of dynamic cost allocation in a vertical axis relative to the aircraft 1.

Such an algorithm thus allows an incremental flight path planning approach in order to calculate the route according to terrain information updates. This lightweight algorithm may be used by a computer configured to calculate a flight path.

Moreover, this computer is advantageously installed on board the aircraft 1.

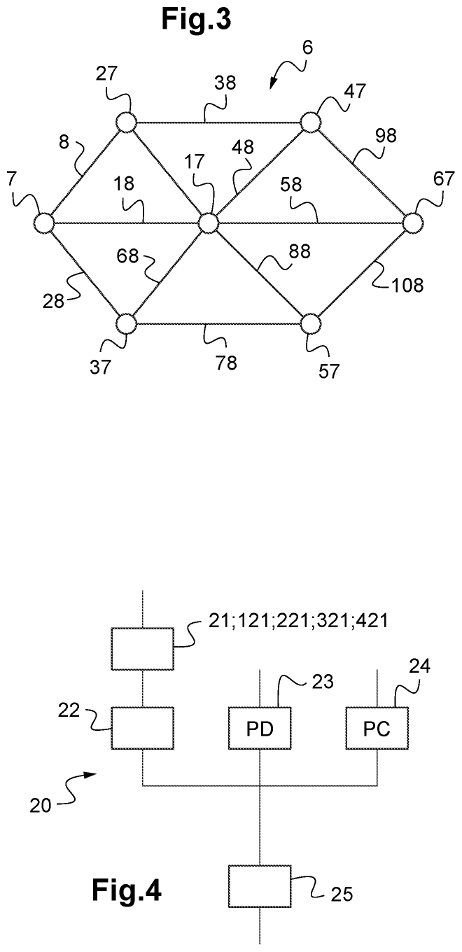

As shown in FIG. 2, such a system 2 for assisting the navigation of an aircraft 1 includes a graph generator 5 configured to generate, for each mission of the aircraft 1, a graph 6 as shown in FIG. 3.

Such a graph 6 comprises nodes 7, 17, 27, 37, 47, 57, and arcs 8, 18, 28, 38, 48, 58, 68, 78, 88, 98, 108 corresponding to a set of preferred waypoints and routes for the aircraft 1. Each arc 8, 18, 28, 38, 48, 58, 68, 78, 88, 98, 108 connects two nodes 7, 17, 27, 37, 47, 57, 67 together and each node 7, 17, 27, 37, 47, 57, 67 is connected to at least one other node 7, 17, 27, 37, 47, 57, 67. The node 7 may, for example, form a starting point, and therefore correspond to the current position PC of the aircraft 1 before carrying out its mission, and the node 67 a destination position PD.

Such a graph 6 is shown here in plan view, for the sake of simplification, and is therefore in two dimensions. However, the graph 6 is preferably formed by a three-dimensional graph or by a superposition of a plurality of 2D graphs connected together by a set of arcs.

Once the graph 6 has been generated on the ground prior to a mission of the aircraft 1, this graph 6 is then transmitted by the graph generator 5 to a memory 9 installed on board the aircraft 1. Such a memory 9 allows the graph 6 to be stored during a mission of the aircraft 1. Optionally, during the mission of the aircraft 1, this graph 6 may be modified by means of information collected in flight and transmitted to the graph generator 5.

Furthermore, the navigation assistance system 2 also comprises a planning member 10 configured to plan a mission and to enter at least one destination position PD for this mission.

For example, such a planning member 10 may include a keyboard, a touchscreen or a touchpad enabling a pilot to enter the destination position PD. Furthermore, such a planning member may have a screen allowing a map to be displayed having landing areas or landing strips that can be selected manually by the pilot of the aircraft 1.

The navigation assistance system 2 also comprises an identification means 11 configured to identify a current position PC of the aircraft 1 in the graph 6.

An on-board camera 13 is arranged on the aircraft 1 and can be used to generate images of the environment surrounding the aircraft 1. These images are captured in flight during the mission of the aircraft 1. Such an on-board camera 13 is connected by wired or wireless means to the identification means 11 and/or to the on-board memory 9 so as to be able to store these images on the aircraft 1.

Furthermore, the navigation assistance system 2 comprises a computer 12 configured to calculate a flight path by means of the graph 6 in order to move from the current position PC of the aircraft 1 to the destination position PD. Such a computer 12 may in particular use an algorithm allowing an incremental flight path planning approach in order to calculate the route according to terrain information updates, and is therefore installed on board the aircraft 1.

Such a computer 12 is connected by wired or wireless means to the graph generator 5, the planning member 10 and the identification means 11.

Moreover, the graph generator 5 is configured to assign an image usability index to each arc 8, 18, 28, 38, 48, 58, 68, 78, 88, 98, 108 of the graph 6, making it possible to quantify, for the identification means 11, a probability of identifying the current position PC of the aircraft 1. In addition, the means 11 for identifying the current position PC of the aircraft 1 uses at least images captured in flight by the on-board camera 13 during the mission of the aircraft 1.

The graph generator 5, the identification means 11 and the computer 12 may be separate from each other as shown in FIG. 2 and each may, for example, comprise at least one processor and at least one memory, at least one integrated circuit, at least one programmable system, and at least one logic circuit, these examples not limiting the scope given to the expressions “graph generator”, “identification means” and “computer”. The term “processor” may refer equally to a central processing unit (CPU), a graphics processing unit (GPU), a digital signal processor (DSP), a microcontroller, etc.

Alternatively, the graph generator 5, the identification means 11 and the computer 12 may also be combined in one and the same processing unit.

As shown in FIG. 3, the flight path calculated by the computer 12 is not necessarily the shortest path and can, for example, pass successively through the nodes 7, 37, 57, 17, 47 and 67 to reach the destination position PD.

In this case, the flight path formed by the arcs 28, 78, 88, 48 and 98 is that which allows the safest vision-based navigation and therefore has the greatest probability of satisfying the step 24 of identifying the current position PC.

As shown in FIG. 4, the disclosure also relates to a method 20 for assisting the navigation of an aircraft 1.

Such a method 20 includes a step 21, 121, 221, 321, 421 of generating a graph 6 according to FIG. 3 corresponding to a set of preferred waypoints and routes for the aircraft 1.

According to a first embodiment of the disclosure, the step 21 of generating the graph 6 may be carried out by means of imaging data.

According to a second embodiment of the disclosure, the step 121 of generating the graph 6 may be carried out by means of the images captured in flight during the mission of the aircraft 1.

According to a third embodiment of the disclosure, the step 221 of generating the graph 6 may be carried out by means of digital terrain models.

According to a fourth embodiment of the disclosure, the step 321 of generating the graph 6 may be carried out by means of a geographic information system database.

According to a fifth embodiment of the disclosure, the step 421 of generating the graph 6 may be carried out by means of imaging data, digital terrain models and a geographic information system database.

Once the graph 6 has been generated, the method 20 then includes a step 22 of storing the graph 6 in the on-board memory 9 installed on the aircraft 1.

Furthermore, the method 20 also includes a step 23 of planning a mission to reach a destination position PD and a step 24 of identifying a current position PC of the aircraft 1 in the graph 6.

The method 20 then includes a step 25 of calculating a flight path by means of the graph 6 in order to move from the current position PC of the aircraft 1 to the destination position PD.

Also, the order of the steps is not mandatory. Thus, it is possible to carry out the step 121 of generating a graph in flight, in particular for the purpose of updating the graph. Such updating of the graph in flight is carried out in series with the step 22 of storing the graph 6 in a memory installed on board the aircraft 1. This step 121 of generating the graph 6 can therefore be carried out after a step 23 of planning a mission to reach a destination position PD and/or after a step 24 of identifying a current position PC of the aircraft 1 on an arc 8, 18, 28, 38, 48, 58, 68, 78, 88, 98, 108 of the graph 6.

Moreover, according to such a vision-based navigation assistance method 20, the step 24 of identifying a current position PC of the aircraft 1 on an arc 8, 18, 28, 38, 48, 58, 68, 78, 88, 98, 108 and the step 25 of calculating a flight path can be implemented in loops in a regular manner and automatically at a predetermined frequency, thus making it possible at any instant to update the actual trajectory followed by the aircraft with respect to the flight path.

As already mentioned, such a graph 6 is remarkable in that each arc 8, 18, 28, 38, 48, 58, 68, 78, 88, 98, 108 is assigned an image usability index making it possible to quantify a probability of satisfying the step 24 of identifying the current position PC and in that the step 24 of identifying the current position PC is carried out by means of images captured in flight during the mission of the aircraft 1.

Also, the image usability indices are between 0 and 1, and the step 25 of calculating a flight path gives preference to the arcs 8, 18, 28, 38, 48, 58, 68, 78, 88, 98, 108 having the highest image usability indices. The calculation step 25 then adds up all the possible flight paths and can then make it possible to indicate, to a pilot, a flight path giving preference to vision-based navigation rather than a flight path giving preference to the shortest distance to be covered between the current position PC and the destination position PD.

The image usability indices may, in particular, be calculated as a function of at least one parameter selected from the group comprising a texture level of zones of the graph 6, a number of items of imaging data included in the zones of the graph 6, a confidence level relating to recognition of the imaging data, the existence of a spatial relationship between the items of imaging data, an altitude corresponding to the current position PC of the aircraft 1 and flight conditions of the mission.

Naturally, the present disclosure is subject to numerous variations as regards its implementation. Although several implementations are described above, it should readily be understood that an exhaustive identification of all possible embodiments is not conceivable. It is naturally possible to replace any of the means described with equivalent means without going beyond the ambit of the present disclosure.

What is claimed is:

1. A method for assisting the navigation of an aircraft, the method including the following steps:
generating a graph comprising nodes and arcs corresponding to a set of preferred waypoints and routes for the aircraft, each arc connecting two nodes to each other and each node being connected to at least one other node;
storing the graph in a memory installed on board the aircraft;
planning a mission to reach a destination position;
identifying a current position of the aircraft in the graph, the step of identifying the current position being carried out by means of images captured in flight during the mission of the aircraft; and
calculating a flight path by means of the graph in order to move from the current position of the aircraft to the destination position,
wherein each arc of the graph is assigned an image usability index enabling to quantify a probability of satisfying the step of identifying the current position, the step (24) of identifying the current position being carried out at any instant on one of the arcs of the graph arranged between two consecutive nodes and wherein the calculation of a flight path is carried out depending on the image usability indices of the arcs.

2. The method according to claim 1
wherein, the image usability indices being between 0 and 1, the step of calculating a flight path gives preference to the arcs having the highest image usability indices.

3. The method according to claim 1
wherein the step of generating a graph is carried out by means of imaging data.

4. The method according to claim 1
wherein the step of generating a graph is carried out by means of the images captured in flight during the mission of the aircraft.

5. The method according to claim 1
wherein the step of generating a graph is carried out by means of digital terrain models.

6. The method according to claim 1
wherein the step of generating a graph is carried out by means of a geographic information system database.

7. The method according to claim 1
wherein the image usability indices are calculated as a function of at least one parameter selected from the group comprising a texture level of zones of the graph, a number of items of imaging data included in the zones of the graph, a confidence level relating to recognition of the imaging data, the existence of a spatial relationship between the items of imaging data, an altitude corresponding to the current position of the aircraft, and flight conditions of the mission.

8. A system for assisting the navigation of an aircraft, the system including:
a graph generator for generating a graph comprising nodes and arcs corresponding to a set of preferred waypoints and routes for the aircraft, each arc connecting two nodes to each other and each node being connected to at least one other node;
a memory installed on board the aircraft for storing the graph;
a planning member configured to plan a mission and to enter at least one destination position for the mission;
an identification means configured to identify a current position of the aircraft in the graph, the means for identifying the current position of the aircraft using at least images captured in flight during the mission of the aircraft; and
a computer configured to calculate a flight path by means of the graph in order to move from the current position of the aircraft to the destination position,
wherein the graph generator is configured to assign, to each arc of the graph, an image usability index enabling to quantify, for the identification means, a probability of identifying the current position of the aircraft, the identification means identifying, at any instant, the current position of the aircraft on one of the arcs of the graph arranged between two consecutive nodes and wherein the computer calculates the flight path depending on the image usability indices of the arcs.

9. The system according to claim 8
wherein the system includes at least one on-board camera installed on the aircraft in order to generate the images captured in flight during the mission of the aircraft.

10. The system according to claim 8
wherein the system is installed on board the aircraft.

11. An aircraft wherein the aircraft comprises the system for assisting the navigation of the aircraft according to claim 8.

12. The aircraft according to claim 11
wherein, the aircraft comprising a satellite positioning system, the navigation assistance system is configured to compensate for a malfunction of the satellite positioning system.

13. The aircraft according to claim 11
wherein the navigation assistance system is configured to interface with a control unit for piloting the aircraft.
